(19) United States
(12) Patent Application Publication
(10) Pub. No.: US 2022/0309698 A1
(43) Pub. Date: Sep. 29, 2022

(54) INFORMATION PROCESSING DEVICE, INFORMATION PROCESSING METHOD, PROGRAM, AND CAMERA MODULE

(71) Applicant: SONY GROUP CORPORATION, TOKYO (JP)

(72) Inventors: YUSUKE TAKAHASHI, TOKYO (JP); DAI KOBAYASHI, TOKYO (JP); RYO WATANABE, TOKYO (JP); MASATAKA TOYOURA, TOKYO (JP)

(21) Appl. No.: 17/597,160

(22) PCT Filed: Jul. 1, 2020
(86) PCT No.: PCT/JP2020/025757

§ 371 Date: Dec. 28, 2021

(30) Foreign Application Priority Data
Jul. 8, 2019 (JP) 2019-126601

(51) Int. Cl. G06T 7/70; B64C 39/02

(52) U.S. Cl. CPC G06T 7/70; B64C 39/024; G06T 2207/30244; B64C 2201/127; B64C 2201/146; B64C 2201/108; B64C 2201/122; G05D 1/101

(57) ABSTRACT

Provided is a self-position estimation mechanism that can absorb the influence of resetting of a position estimator.

A difference between a position for each epoch and a position of a previous epoch estimated by a first estimation unit using a camera image and IMU information and a velocity and an acceleration for each epoch estimated by a second estimation unit using the camera image and the IMU information are acquired. Whether the difference acquired for each epoch is an outlier is tested on the basis of a threshold and whether the velocity and acceleration acquired for each epoch is an outlier is tested on the basis of a threshold. A self-position is estimated using the difference for each epoch and the velocity and acceleration for each epoch after the outlier is removed.

### TECHNICAL FIELD

The present technology relates to an information processing device, an information processing method, a program, a camera module, and more specifically, an information processing device for estimating a self-position.

### BACKGROUND ART

For example, PTL 1 discloses a technique for improving the robustness and accuracy of self-position estimation by combining a plurality of algorithms having different characteristics. In this technique, a first estimation unit estimates the position of a predetermined target on the basis of the image around the predetermined target acquired from an imaging device, generates an estimation result that does not include the accumulated error. A second estimation unit estimates the position of the predetermined object on the basis of the image around the predetermined object acquired from the imaging device, generates an estimation result including an accumulated error. A correction unit compares the estimation result of the first estimation unit with the estimation result of the second estimation unit and corrects a subsequent estimation result of the second estimation unit subsequent to the estimation result of the second estimation unit used for the comparison on the basis of the comparison result. In this technique, when the self-position loss occurs in the second estimation unit, it cannot be restored. Further, in this technique, when the estimation value of the second estimation unit is reset, the self-position flies. In this specification, “the self-position flies” means that the self-position estimation value becomes discontinuous and diverges.

### CITATION LIST

### Patent Literature

[PTL 1]
JP 2017-072560 A

### SUMMARY

### Technical Problem

VIO (Visual Inertial Odometry) estimates its own position using the amount of change in the feature amount in the camera image and the information of the IMU (inertial measurement unit). In the case of V-SLAM (Vision Simultaneous Localization And Mapping), in addition to the position and attitude of the camera, the position of a feature point in the surrounding environment is estimated as a state quantity. The basic mechanism of V-SLAM performing estimation using the amount of movement of feature points on the image and IMU is the same as that of VIO. The difference is that the positions of the feature points are accumulated as a feature point map, and its own position can be corrected using the feature point map. Both methods use a Kalman filter for state quantity estimation.

When using the Kalman filter, information such as the amount of movement between frames on the camera image, acceleration by the IMU, and angular acceleration is treated as an observed value, but if there is a discrepancy between the movement of the feature amount on the camera image and the movement of the IMU, the state quantity may diverge, resulting in the self-position flying. For example, when an aircraft is stationary but the object in the image moves, the state quantity diverges. In such a case, it is desirable to reset the state quantity because convergence to a correct state quantity cannot be expected.

When the state quantity is reset, the position information that has been accumulated up to now returns to the original state, and as a result, the coordinate system flies. In this specification, “the coordinate system flies” means that the output self-position is completely different because the coordinate system is reset. If the self-position in the flying state of the coordinate system is used, a drone may move in an unexpected direction or fall. Therefore, SLAM reset is a mechanism necessary for robust self-position estimation, but in order to realize reset, a self-position estimation mechanism that can absorb the influence of reset is required.

An object of the present technology is to provide a self-position estimation mechanism that can absorb the influence of resetting a position estimator.

### Solution to Problem

The concept of the present technology is an information processing device including: an information acquisition unit that acquires a difference between a position for each epoch and a position of a previous epoch estimated by a first estimation unit using a camera image and IMU information and a velocity and an acceleration for each epoch estimated by a second estimation unit using the camera image and the IMU information; an outlier test unit that tests whether the difference acquired for each epoch is an outlier on the basis of a threshold and tests whether the velocity and acceleration acquired for each epoch is an outlier on the basis of a threshold; and a third estimation unit that estimates a self-position using the difference for each epoch and the velocity and acceleration for each epoch after the outlier is removed.

In the present technology, the information acquisition unit acquires a difference between a position for each epoch and a position of a previous epoch estimated by a first estimation unit using a camera image and IMU information and a velocity and an acceleration for each epoch estimated by a second estimation unit using the camera image and the IMU information. For example, the first estimation unit may use a V-SLAM algorithm, and the second estimation unit may use a VIO algorithm. Further, for example, the information acquisition unit may be configured to have an input unit for inputting a difference. Further, for example, the information acquisition unit may be configured to have a difference generation unit that inputs the position for each epoch obtained by the first estimation unit and generates a difference from the position of the previous epoch. Here, “epoch” refers to the time when data was acquired, and can be paraphrased as “sample”.

The outlier test unit tests whether the difference acquired for each epoch is an outlier on the basis of a threshold and tests whether the velocity and acceleration acquired for each epoch is an outlier on the basis of a threshold. Then, the third estimation unit estimates a self-position using the difference for each epoch and the velocity and acceleration for each epoch after the outlier is removed.

For example, the information processing device may further include a reset monitoring unit that outputs a reset instruction for resetting the first estimation unit on the basis of a test result of the outlier of the difference obtained by the outlier test unit, and outputs a reset instruction for resetting the second estimation unit on the basis of a test result of the outlier of the velocity and acceleration obtained by the outlier test unit. In this case, for example, the reset monitoring unit may output the reset instruction for resetting the first estimation unit when the difference is an outlier continuously for a threshold or longer, and may output a reset instruction for resetting the second estimation unit continuously for a threshold or longer.

As described above, in the present technology, the third estimation unit that estimates a self-position using the difference for each epoch related to the position estimated by the first estimation unit and the velocity and acceleration for each epoch estimated by the second estimation unit. Since the estimation results obtained using a plurality of algorithms are integrated to perform self-position estimation, for example, even if the first estimation unit is reset and the coordinate system flies, the effect of the reset can be absorbed and self-position estimation can be performed satisfactorily.

Further, in the present technology, the third estimation unit estimates the self-position using the difference for each epoch related to the position estimated by the first estimation unit after the outliers are removed, and the velocity and acceleration for each epoch estimated by the second estimation unit after the outliers are removed. Therefore, the third estimation unit can estimate the self-position accurately. The third estimation unit uses the difference between the position for each epoch and the position of the previous epoch rather than the position itself estimated by the first estimation unit. Therefore, outliers can be tested easily and appropriately.

Another concept of the present technology is a camera module including: a camera; an IMU; a position estimator that estimates a position using an image captured by the camera and information of the IMU; a velocity estimator that estimates a velocity and an acceleration using the image captured by the camera and the information of the IMU; and a difference generator that generates a difference between a position for each epoch and a position of a previous epoch obtained and estimated by the position estimator.

In the present technology, the position estimator estimates the position using the image captured by the camera and the information of the IMU. The velocity estimator estimates the velocity and acceleration using the image captured by the camera and the IMU information. In addition, the difference generator generates a difference between the position for each epoch and the position of the previous epoch estimated and obtained by the position estimator.

As described above, in the present technology, it is possible to obtain the difference for each epoch related to the estimated position and the estimated velocity and acceleration for each epoch and to efficiently supply information to the estimator for estimating the self-position using these pieces of information.

### BRIEF DESCRIPTION OF DRAWINGS

FIG. 1 is a block diagram showing a configuration example of a flight system.

FIG. 2 is a diagram showing an example of the appearance of a flight device.

FIG. 3 is a block diagram showing a configuration example of a self-position estimation system included in a flight device.

FIG. 4 is a diagram schematically showing the flying of the coordinate system at the time of reset in a position estimator using a V-SLAM algorithm.

FIG. 5 is a block diagram showing a more specific configuration example of the self-position estimation system included in the flight device.

FIG. 6 is a diagram for explaining the mechanism of outlier test.

FIG. 7 is a flowchart showing an example of a processing procedure of the position estimator.

FIG. 8 is a flowchart showing an example of a processing procedure of the difference generator.

FIG. 9 is a flowchart showing an example of a processing procedure of a velocity estimator.

FIG. 10 is a flowchart showing an example of a processing procedure of an outlier test unit.

FIG. 11 is a flowchart showing an example of a processing procedure of a reset monitoring unit.

### DESCRIPTION OF EMBODIMENTS

Hereinafter, modes for carrying out the present invention (hereinafter referred to as embodiments) will be described. The description will be made in the following order.

### 1. Embodiment

### 2. Modification

### 1. Embodiment

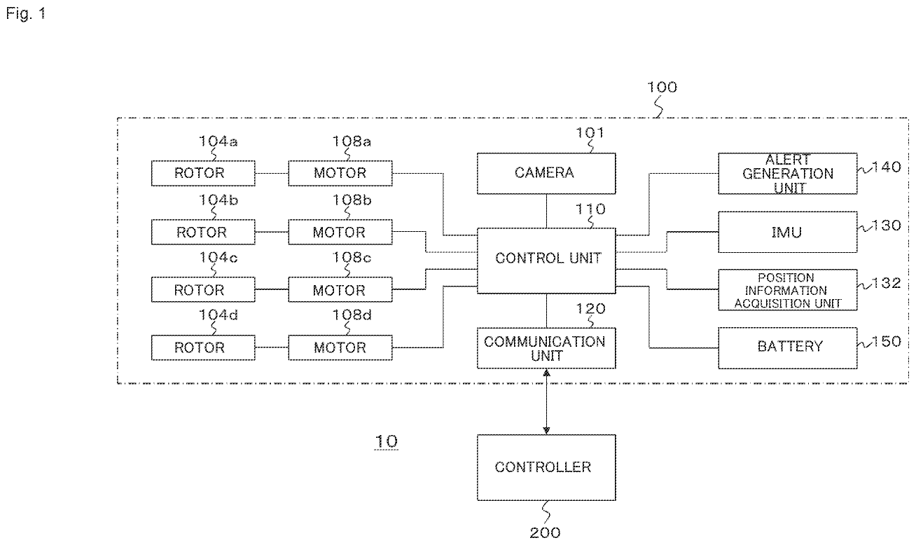

FIG. 1 shows a configuration example of a flight system 10. The flight system 10 includes a flight device (drone) 100 and a controller 200. A user uses the controller 200 to control the operation of the flight device 100.

The flight device 100 includes a camera 101, rotors 104a to 104d, motors 108a to 108d, a control unit 110, a communication unit 120, an IMU 130, a position information acquisition unit 132, an alert generation unit 140, and a battery 150.

The control unit 110 controls the operation of each unit of the flight device 100. For example, the control unit 110 can control adjustment of the rotation speed of the rotors 104a to 104d by adjusting the rotation speed of the motors 108a to 108d, imaging processing by the camera 101, and transmission and reception of information to and from another device (for example, a controller 200) via the communication unit 120, alert generation processing of the alert generation unit 140, and the like.

The camera 101 includes lenses and an image sensor such as a CCD image sensor or a CMOS image sensor. The rotors 104a to 104d allow the flight device 100 to fly by generating lift by rotation. The rotation of the rotors 104a to 104d is performed by the rotation of the motors 108a to 108d. The rotation of the motors 108a to 108d can be controlled by the control unit 110.

The communication unit 120 performs information transmission and reception processing by wireless communication with the controller 200. The flight device 100 transmits an image captured by the camera 101 from the communication unit 120 to the controller 200. The flight device 100 receives an instruction regarding flight from the controller 200 via the communication unit 120.

The IMU 130 acquires information on the acceleration and angular acceleration of the flight device 100. The IMU 130 can provide the acquired information on the acceleration and the angular acceleration of the flight device 100 to the control unit 110, if necessary. The position information acquisition unit 132 acquires information on the current position of the flight device 100 using, for example, GPS (Global Positioning System) or the like. The position information acquisition unit 132 may provide the acquired information on the current position of the flight device 100 to the control unit 110, if necessary.

When the flight device 100 tries to fly beyond a preset flight range, the alert generation unit 140 generates an alert such as sound or light under the control of the control unit 110. The battery 150 stores electric power for operating the flight device 100. The battery 150 may be a primary battery that can be discharged only or a secondary battery that can be charged.

Information can be transmitted and received between the flight device 100 and the controller 200 by, for example, wireless communication using the 2.4 GHz band, 5 GHz band, or other frequency bands according to the IEEE 802.11 standard, the IEEE 802.15.1 standard, or other standards.

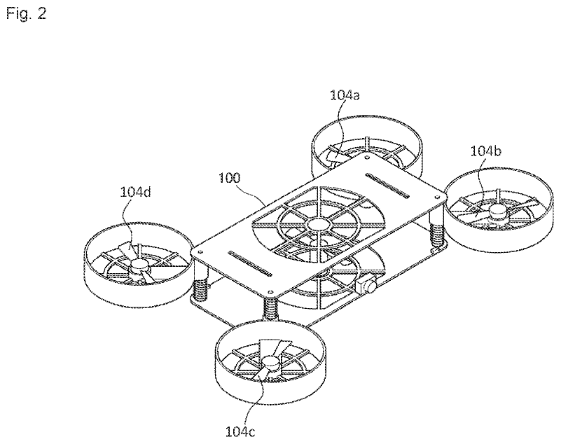

FIG. 2 schematically shows the appearance of an example of the flight device 100. In FIG. 2, the parts corresponding to those in FIG. 1 are designated by the same reference numerals.

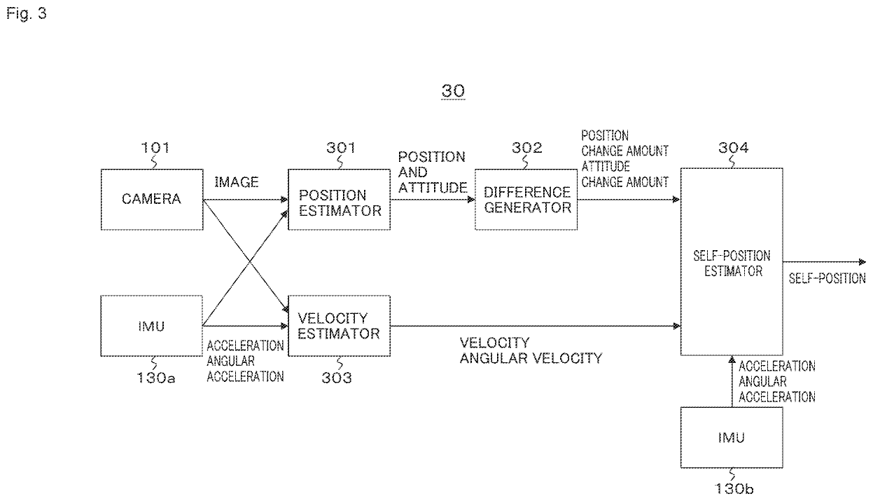

FIG. 3 shows a configuration example of a self-position estimation system 30 included in the flight device 100. In FIG. 3, the parts corresponding to those in FIG. 1 are designated by the same reference numerals, and detailed description thereof will be omitted as appropriate. The self-position estimation system 30 includes a camera 101, IMUs 130a and 130b, a position estimator 301, a difference generator 302, a velocity estimator 303, and a self-position estimator 304. Here, the camera 101 may be a stereo camera. Here, the position estimator 301 constitutes a first estimation unit, the velocity estimator 303 constitutes a second estimation unit, and the self-position estimator 304 constitutes a third estimation unit.

The position estimator 301 estimates the position and attitude of the flight device 100 for each epoch on the basis of the image obtained by the camera 101 and the information (acceleration and angular acceleration) obtained by the IMU 130, for example, using the V-SLAM algorithm. The difference generator 302 inputs the position and attitude estimated for each epoch by the position estimator 301, generates a difference (position change amount and attitude change amount) between the position and attitude for each epoch and the position and attitude of the previous epoch, and output the difference for each epoch.

The velocity estimator 303 estimates the velocity and angular velocity of the flight device 100 for each epoch on the basis of the image obtained by the camera 101 and the information (acceleration and angular acceleration) obtained by the IMU 130a, for example, using the VIO algorithm. The self-position estimator 304 is a self-position estimator specific to the flight device. The self-position estimator 304 estimates the self-position on the basis of the position change amount and the attitude change amount for each epoch obtained by the difference generator 302, the velocity and angular velocity for each epoch obtained by the velocity estimator 303, and information (acceleration and angular acceleration) obtained by the IMU 130b.

In this self-position estimation system 30, the IMU 130a and the IMU 130b may be the same or different. In the self-position estimation system 30, the difference generator 302 may be included in a camera module. In that case, the camera module is assumed to include, for example, the camera 101, the IMU 130a, the position estimator 301, the velocity estimator 303, and the difference generator 302. Further, a part or all of the processing of each part in the self-position estimation system 30 can be performed by software processing by a computer. Further, in the self-position estimation system 30, the difference generator 302 exists outside the self-position estimator 304, but the self-position estimator 304 may include a difference generation unit having the same function as the difference generator 302. In this way, the self-position estimator 304 has an input unit for inputting a difference (position change amount and attitude change amount) as an information acquisition unit, or a difference generation unit having the same function as the difference generator 302.

In the self-position estimation system 30 shown in FIG. 3, the estimation results obtained using a plurality of algorithms are integrated to perform self-position estimation, and the self-position estimator 304 can continuously estimate the self-position even while the position estimator 301 is reset, for example.

Further, in the self-position estimation system 30 shown in FIG. 3, the position itself for each epoch obtained by the position estimator 301 is not used by the self-position estimator 304, but the difference between the position for each epoch and the position of the previous epoch is used. Therefore, the outlier can be easily and appropriately tested, and for example, the influence of the flying of the coordinate system caused by the reset of the position estimator 301 can be suppressed.

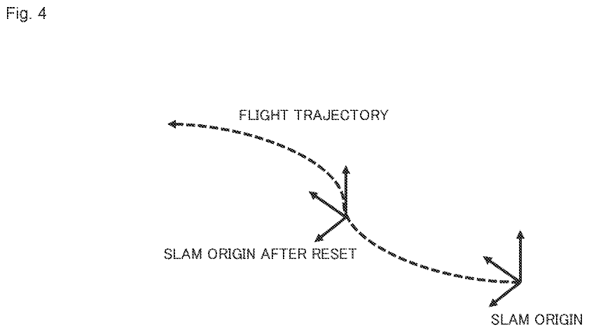

FIG. 4 schematically shows the flying of the coordinate system at the time of reset in the position estimator 301 which uses the V-SLAM algorithm, for example. In this case, the SLAM origin moves due to the reset, and flying of the coordinate system occurs.

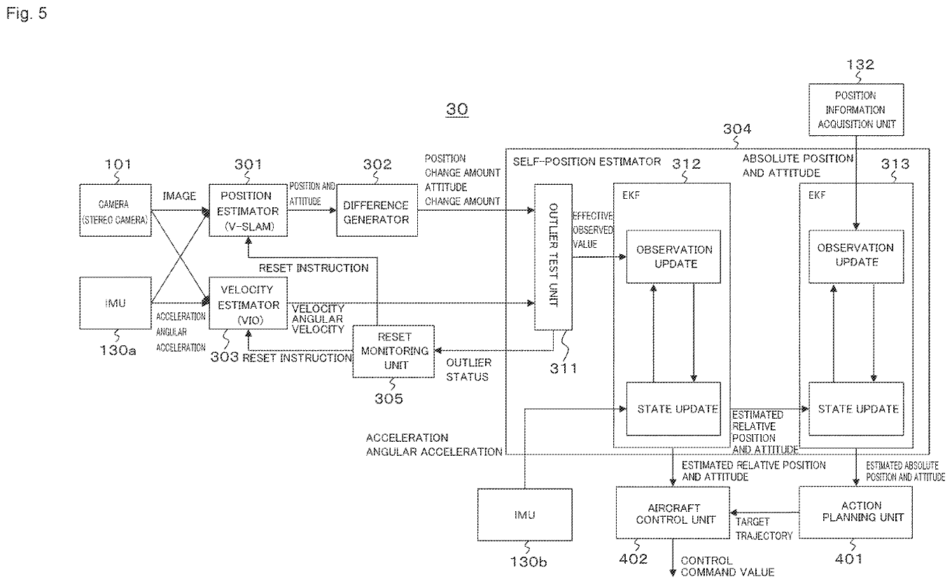

FIG. 5 shows a more specific configuration example of the self-position estimation system 30 included in the flight device 100. In FIG. 5, the parts corresponding to those in FIG. 3 are designated by the same reference numerals, and detailed description thereof will be omitted as appropriate.

The self-position estimation system 30 includes a reset monitoring unit 305 as well as the camera 101, the IMUs 130a and 130b, the position estimator 301, the difference generator 302, the velocity estimator 303, and the self-position estimator 304. The self-position estimator 304 has an outlier test unit 311, an EKF self-position estimation unit 312, and an EKF self-position estimation unit 313.

The outlier test unit 311 tests whether or not the difference (position change amount and attitude change amount) for each epoch supplied from the difference generator 302 is an outlier on the basis of a threshold. Then, the outlier test unit 311 sends the difference for each epoch after the outlier is removed to the EKF self-position estimation unit 312 as an effective observed value, and sends a difference outlier status which is an outlier test result for the difference for each epoch to the reset monitoring unit 305. The outlier test unit 311 also constitutes an input unit for inputting a difference (position change amount and attitude change amount).

### “Outlier Test Mechanism”

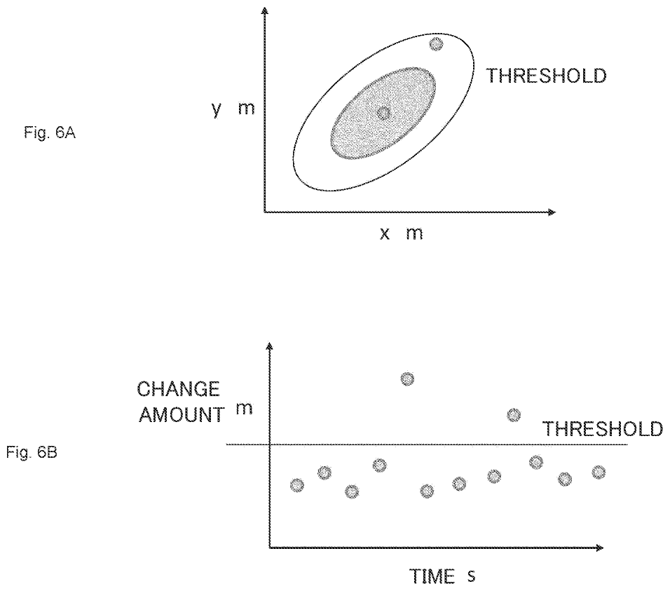

Here, the mechanism of the outlier test will be described. In the outlier test using a general method such as GPS or SLAM that directly outputs the self-position, the method using the Mahalanobis distance is often used (see FIG. 6(a)). The idea is that if the estimated state quantity and the observed quantity are significantly different, the observed quantity is rejected as an outlier, and the Mahalanobis distance is used as a threshold. Since the Mahalanobis distance is a distance that takes covariance into consideration and the Kalman filter also estimates the covariance, the Mahalanobis distance is often used in outlier tests in the Kalman filter.

However, in order for the outlier test mechanism to produce sufficient outlier test performance, it is necessary to appropriately set its own covariance and the covariance of the observed values. In self-position estimation using EKF, in order to accurately estimate the covariance, the noise of all the sensors used must be white, and the noise magnitude must be estimated accurately. In addition, the process noise needs to be set appropriately. In practice, the sensor noise is rarely white, and when an external sensor is used, the noise characteristics change depending on the environment.

It is very difficult to accurately estimate the covariance of the self-position in such a situation. When observing and updating using difference information as in this embodiment, since whether or not it is an outlier can be set according to specifications such as the movement performance of the aircraft such that the actual object does not move for more than XX m per second, it is possible to perform realistic outlier test (see FIG. 6(b)).

The outlier test unit 311 tests whether or not the velocity and angular velocity for each epoch supplied from the velocity estimator 303 is an outlier on the basis of a threshold. Then, the outlier test unit 311 sends the velocity and angular velocity for each epoch after the outlier is removed to the EKF self-position estimation unit 312 as an effective observed value, and sends a velocity and angular velocity outlier status which is an outlier test result for the velocity and angular velocity for each epoch to the reset monitoring unit 305.

For example, if it is assumed that the velocity and acceleration is obtained at 100 Hz from the velocity estimator 303, the position and attitude is obtained at 10 Hz from the position estimator 301, and the flight device 100 does not move at a velocity of 1 m or more per second, there is a high possibility that the higher velocity is an outlier, and a movement amount, which is the difference, of 0.1 m or more is an outlier.

The reset monitoring unit 305 outputs a reset instruction to the position estimator 301 on the basis of the difference outlier status. For example, the reset monitoring unit 305 outputs the reset instruction to the position estimator 301 when the difference is an outlier continuously for a preset threshold or longer. The position estimator 301 resets when it receives a reset instruction from the reset monitoring unit 305.

The reset monitoring unit 305 outputs a reset instruction to the velocity estimator 303 on the basis of the velocity and acceleration outlier status. For example, the reset monitoring unit 305 outputs the reset instruction to the velocity estimator 303 when the velocity and acceleration is an outlier continuously for a preset threshold or longer. The velocity estimator 303 resets when it receives a reset instruction from the reset monitoring unit 305.

The EKF self-position estimation unit 312 is a Kalman filter capable of estimating a continuous relative position although a cumulative error occurs. The EKF self-position estimation unit 312 updates observations and states on the basis of the effective observation value supplied from the outlier test unit 311 and the information (acceleration and angular acceleration) obtained by the IMU 130b, and outputs an estimated relative position and attitude.

The EKF self-position estimation unit 313 is a Kalman filter that can estimate an absolute position, although it is not a continuous value, using a sensor that can obtain the estimated amount and the absolute position and attitude of the EKF self-position estimation unit 312. The EKF self-position estimation unit 313 updates observations and states on the basis of the relative position and attitude estimated by the EKF self-position estimation unit 312 and the absolute position and attitude obtained by the position information acquisition unit 132, and outputs an estimated absolute position and attitude.

The absolute position and attitude estimated by the EKF self-position estimation unit 313 is used by an action planning unit 401. The relative position and attitude estimated by the EKF self-position estimation unit 312 and a target trajectory obtained by the action planning unit 401 are used by an aircraft control unit 402. A control command value for controlling the aircraft is output from the aircraft control unit 402.

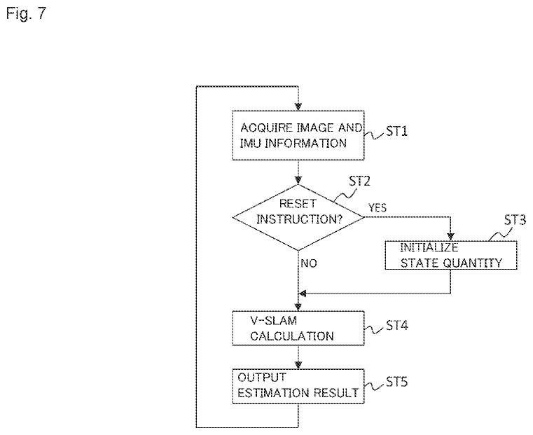

The flowchart of FIG. 7 shows an example of the processing procedure of the position estimator 301. The position estimator 301 acquires an image and IMU information (acceleration and angular acceleration) in step ST1. Next, the position estimator 301 determines in step ST2 whether or not there is a reset instruction from the reset monitoring unit 305. When there is no reset instruction, the process immediately proceeds to step ST4. On the other hand, when there is a reset instruction, the position estimator 301 proceeds to the process of step ST4 after resetting, that is, initializing the state quantity (position and attitude) in step ST3. By this reset, the position information that has been accumulated up to now returns to the original state, and as a result, the coordinate system flies.

In step ST4, the position estimator 301 performs position estimation, that is, V-SLAM calculation, to estimate the position and attitude. Next, the position estimator 301 outputs the estimation result, that is, the estimated position and attitude to the difference generator 302 in step ST5. After the process of step ST5, the position estimator 301 returns to the process of step ST1 and repeats the same process as described above.

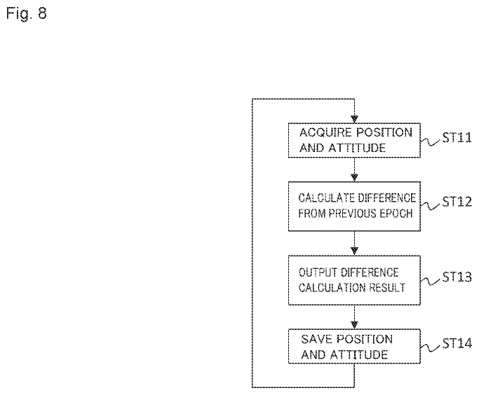

The flowchart of FIG. 8 shows an example of the processing procedure of the difference generator 302. In step ST11, the difference generator 302 acquires the position and attitude of the current epoch estimated by the position estimator 301. Next, in step ST12, the difference generator 302 calculates the difference from the previous epoch (previous time), that is, the amount of change from the previous epoch (position change amount and attitude change amount).

Next, in step ST13, the difference generator 302 outputs the amount of change (position change amount and attitude change amount), which is the difference calculation result, to the self-position estimator 304. Next, in step ST14, the difference generator 302 saves the position and attitude of the current epoch for the difference calculation in the next epoch. After the process of step ST14, the difference generator 302 returns to the process of step ST11 and repeats the same process as described above.

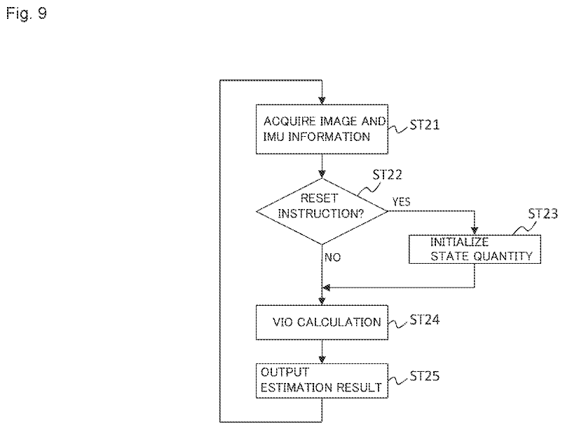

The flowchart of FIG. 9 shows an example of the processing procedure of the velocity estimator 303. The velocity estimator 303 acquires an image and IMU information (acceleration and angular acceleration) in step ST21. Next, the velocity estimator 303 determines in step ST22 whether or not there is a reset instruction from the reset monitoring unit 305. When there is no reset instruction, the process immediately proceeds to step ST24. On the other hand, when there is a reset instruction, the velocity estimator 303 proceeds to the process of step ST24 after resetting, that is, initializing the state quantity (velocity and angular velocity) in step ST23.

In step ST24, the velocity estimator 303 performs velocity estimation, that is, VIO calculation, to estimate the velocity and angular velocity. Next, the velocity estimator 303 outputs the estimation result, that is, the estimated velocity and angular velocity, to the self-position estimator 304 in step ST25. After the process of step ST25, the velocity estimator 303 returns to the process of step ST21 and repeats the same process as described above.

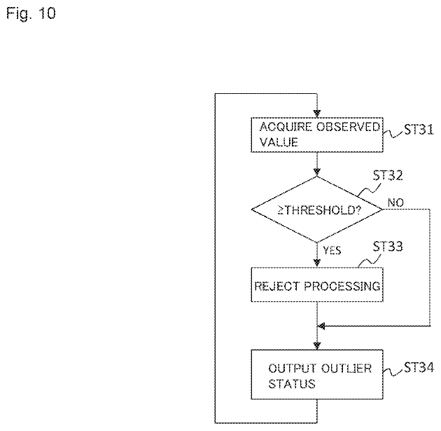

The flowchart of FIG. 10 shows an example of the processing procedure of the outlier test unit 311. In step ST31, the outlier test unit 311 acquires the observed values (the difference from the difference generator 302 and the velocity and angular velocity from the velocity estimator 303). Next, the outlier test unit 311 determines in step ST32 whether or not the observed value is equal to or higher than the threshold.

If it is not equal to or higher than the threshold, the process immediately proceeds to step ST34. At this time, the observed value is supplied to the EKF self-position estimation unit 312 as an effective observed value. On the other hand, when it is equal to or higher than the threshold, the outlier test unit 311 performs the rejection process in step ST33, that is, proceeds to the process of step ST34 without supplying the observed value to the EKF self-position estimation unit 312.

In step ST34, the outlier test unit 311 outputs the outlier status, that is, information indicating whether or not the outlier has occurred, to the reset monitoring unit 305. After the processing of step ST34, the outlier test unit 311 returns to the process of step ST31 and repeats the same processing as described above.

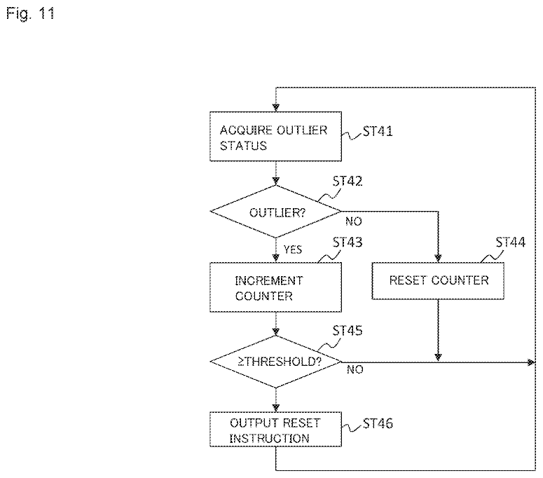

The flowchart of FIG. 11 shows an example of the processing procedure of the reset monitoring unit 305. In step ST41, the reset monitoring unit 305 acquires the outlier status from the outlier test unit 311. There are two types of outlier status, the difference and the velocity and angular velocity, but the processing here is performed separately for each type of outlier status.

Next, in step ST42, the reset monitoring unit 305 determines whether or not the outlier status is an outlier. If it is not an outlier, the reset monitoring unit 305 resets the counter, that is, sets it to zero in step ST44, and then returns to the process of step ST41. On the other hand, if it is an outlier, the reset monitoring unit 305 increments the counter in step ST43, that is, counts up by 1, and then proceeds to the process of step ST46.

In step ST45, the reset monitoring unit 305 determines whether or not the count value of the counter is equal to or higher than a preset threshold. When it is not equal to or higher than the threshold, the reset monitoring unit 305 returns to the process of step ST41. On the other hand, when the value is equal to or higher than the threshold, the reset monitoring unit 305 outputs a reset instruction to the estimator (the position estimator 301 or the velocity estimator 302) in step ST46. After the process of step ST46, the reset monitoring unit 305 returns to the process of step ST41 and repeats the same process as described above.

As described above, in the self-position estimation system 30 shown in FIGS. 3 and 5, the self-position estimator 304 estimates the self-position using the difference for each epoch related to the position and attitude estimated by the position estimator 301 and the velocity and acceleration for each epoch estimated by the velocity estimator 303. Since the estimation results obtained using a plurality of algorithms are integrated to perform self-position estimation, for example, even if the position estimator 301 is reset and the coordinate system flies, it is possible to absorb the influence of the reset and perform self-position estimation satisfactorily.

Further, in the self-position estimation system 30 shown in FIGS. 3 and 5, the self-position estimator 304 estimates the self-position and attitude using the difference for each epoch related to the position and attitude estimated by the position estimator 301 after outliers are removed and the velocity and acceleration for each epoch estimated by the velocity estimator 303 after outliers are removed. Therefore, the self-position and attitude can be accurately estimated by the self-position estimator 304. The self-position estimator 304 uses the difference between the position and attitude for each epoch and the position and attitude of the previous epoch rather than the position and attitude itself estimated by the velocity estimator 303. Therefore, outliers can be tested easily and appropriately.

### 2. Modification

In the above-described embodiment, an example in which the present technology is applied to the flight device (drone) 100 is shown. Although detailed description is omitted, the present technology can be similarly applied to self-position detection in other moving objects such as vehicles and robots.

The preferred embodiment of the present disclosure has been described in detail with reference to the appended drawings, but the technical scope of the present disclosure is not limited to the example. It should be apparent to those skilled in the art in the technical fields of the present disclosure that various change examples or correction examples can be made within the scope of the technical spirit described in the claims and are, of course, construed to belong to the technical scope of the present disclosure.

Further, the effects described in the present specification are merely explanatory or exemplary and are not intended as limiting. That is, the techniques according to the present disclosure may exhibit other effects apparent to those skilled in the art from the description herein, in addition to or in place of the above effects.

The present technology can be configured as follows.

(1) An information processing device including: an information acquisition unit that acquires a difference between a position for each epoch and a position of a previous epoch estimated by a first estimation unit using a camera image and IMU information and a velocity and an acceleration for each epoch estimated by a second estimation unit using the camera image and the IMU information; an outlier test unit that tests whether the difference acquired for each epoch is an outlier on the basis of a threshold and tests whether the velocity and acceleration acquired for each epoch is an outlier on the basis of a threshold; and a third estimation unit that estimates a self-position using the difference for each epoch and the velocity and acceleration for each epoch after the outlier is removed.
(2) The information processing device according to (1), further including: a reset monitoring unit that outputs a reset instruction for resetting the first estimation unit on the basis of a test result of the outlier of the difference obtained by the outlier test unit, and outputs a reset instruction for resetting the second estimation unit on the basis of a test result of the outlier of the velocity and acceleration obtained by the outlier test unit.
(3) The information processing device according to (2), wherein the reset monitoring unit outputs the reset instruction for resetting the first estimation unit when the difference is an outlier continuously for a threshold or longer, and outputs a reset instruction for resetting the second estimation unit continuously for a threshold or longer.
(4) The information processing device according to any one of (1) to (3), wherein the first estimation unit uses a V-SLAM algorithm, and the second estimation unit uses a VIO algorithm.
(5) The information processing device according to any one of (1) to (4), wherein the information acquisition unit has an input unit for inputting the difference.
(6) The information processing device according to any one of (1) to (4), wherein the information acquisition unit has a difference generation unit that receives the position for each epoch obtained by the first estimation unit and generates a difference from the position of the previous epoch.
(7) An information processing method including: acquiring a difference between a position for each epoch and a position of a previous epoch estimated by a first estimation unit using a camera image and IMU information and a velocity and an acceleration for each epoch estimated by a second estimation unit using the camera image and the IMU information; testing whether the difference acquired for each epoch is an outlier on the basis of a threshold and testing whether the velocity and acceleration acquired for each epoch is an outlier on the basis of a threshold; and estimating a self-position using the difference for each epoch and the velocity and acceleration for each epoch after the outlier is removed.
(8) A program for causing a computer to function as: means for acquiring a difference between a position for each epoch and a position of a previous epoch estimated by a first estimation unit using a camera image and IMU information and a velocity and an acceleration for each epoch estimated by a second estimation unit using the camera image and the IMU information; means for testing whether the difference acquired for each epoch is an outlier on the basis of a threshold and testing whether the velocity and acceleration acquired for each epoch is an outlier on the basis of a threshold; and means for estimating a self-position using the difference for each epoch and the velocity and acceleration for each epoch after the outlier is removed.
(9) A camera module including: a camera; an IMU; a position estimator that estimates a position using an image captured by the camera and information of the IMU; a velocity estimator that estimates a velocity and an acceleration using the image captured by the camera and the information of the IMU; and a difference generator that generates a difference between a position for each epoch and a position of a previous epoch obtained and estimated by the position estimator.

### REFERENCE SIGNS LIST

10 Flight system
30 Self-position estimation system
100 Flight device (Drone)
101 Camera
104a to 104d Rotor
108a to 108d Motor
110 Control unit
120 Communication unit
130, 130a, 130b IMU
132 Position information acquisition unit
140 Alert generation unit
150 Battery
200 Controller
301 Position estimator
302 Difference generator
303 Velocity estimator
304 Self-position estimator
305 Reset monitoring unit
311 Outlier test unit
312 EKF self-position estimation unit
313 EKF self-position estimation unit
401 Action planning unit
402 Aircraft control unit

1. An information processing device comprising:
an information acquisition unit that acquires a difference between a position for each epoch and a position of a previous epoch estimated by a first estimation unit using a camera image and IMU information and a velocity and an acceleration for each epoch estimated by a second estimation unit using the camera image and the IMU information;
an outlier test unit that tests whether the difference acquired for each epoch is an outlier on the basis of a threshold and tests whether the velocity and acceleration acquired for each epoch is an outlier on the basis of a threshold; and
a third estimation unit that estimates a self-position using the difference for each epoch and the velocity and acceleration for each epoch after the outlier is removed.

2. The information processing device according to claim 1, further comprising:
a reset monitoring unit that outputs a reset instruction for resetting the first estimation unit on the basis of a test result of the outlier of the difference obtained by the outlier test unit, and outputs a reset instruction for resetting the second estimation unit on the basis of a test result of the outlier of the velocity and acceleration obtained by the outlier test unit.

3. The information processing device according to claim 2, wherein the reset monitoring unit outputs the reset instruction for resetting the first estimation unit when the difference is an outlier continuously for a threshold or longer, and outputs a reset instruction for resetting the second estimation unit continuously for a threshold or longer.

4. The information processing device according to claim 1, wherein the first estimation unit uses a V-SLAM algorithm, and the second estimation unit uses a VIO algorithm.

5. The information processing device according to claim 1, wherein the information acquisition unit has an input unit for inputting the difference.

6. The information processing device according to claim 1, wherein the information acquisition unit has a difference generation unit that receives the position for each epoch obtained by the first estimation unit and generates a difference from the position of the previous epoch.

7. An information processing method comprising:
acquiring a difference between a position for each epoch and a position of a previous epoch estimated by a first estimation unit using a camera image and IMU information and a velocity and an acceleration for each epoch estimated by a second estimation unit using the camera image and the IMU information;
testing whether the difference acquired for each epoch is an outlier on the basis of a threshold and testing whether the velocity and acceleration acquired for each epoch is an outlier on the basis of a threshold; and
estimating a self-position using the difference for each epoch and the velocity and acceleration for each epoch after the outlier is removed.

8. A program for causing a computer to function as:
means for acquiring a difference between a position for each epoch and a position of a previous epoch estimated by a first estimation unit using a camera image and IMU information and a velocity and an acceleration for each epoch estimated by a second estimation unit using the camera image and the IMU information;
means for testing whether the difference acquired for each epoch is an outlier on the basis of a threshold and testing whether the velocity and acceleration acquired for each epoch is an outlier on the basis of a threshold; and
means for estimating a self-position using the difference for each epoch and the velocity and acceleration for each epoch after the outlier is removed.

9. A camera module comprising:
a camera;
an IMU;
a position estimator that estimates a position using an image captured by the camera and information of the IMU;
a velocity estimator that estimates a velocity and an acceleration using the image captured by the camera and the information of the IMU; and
a difference generator that generates a difference between a position for each epoch and a position of a previous epoch obtained and estimated by the position estimator.
